(19) United States
(12) Patent Application Publication
(10) Pub. No.: US 2005/0093798 A1
(43) Pub. Date: May 5, 2005

(54) Correction of uneven image appearance by use of small-size data

(75) Inventors: Tsuyoshi Kamada, Kawasaki (JP); Kazuhiro Nukiyama, Kawasaki (JP); Toshiaki Suzuki, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU DISPLAY TECHNOLOGIES CORPORATION

(21) Appl. No.: 10/843,039

(22) Filed: May 11, 2004

(30) Foreign Application Priority Data
Oct. 29, 2003 (JP) 2003-369317

(51) Int. Cl. G09G 3/36; G09G 5/00; H04N 1/46

(52) U.S. Cl. 345/89; 345/204

(57) ABSTRACT

A circuit for display correction includes a memory which stores first data indicative of size and position of a rectangular region on a display screen and second data indicative of gray level changes in a surrounding region around the rectangular region in an isometric manner with respect to a horizontal direction and a vertical direction, and an image processing unit which adjusts gray levels of image data in response to the first data and the second data stored in the memory.

### BACKGROUND OF THE INVENTION

1. Field of the Invention

The present invention generally relates to display correction circuits and display apparatuses, and particularly relates to a display correction circuit and a display apparatus which correct uneven image appearance caused by the characteristics of the display apparatus.

2. Description of the Related Art

In liquid crystal display apparatuses, plasma display apparatuses, or the like, uneven image appearance may be observed when display brightness becomes darker or brighter, for example, than desired brightness at some places on the screen. In the liquid crystal display apparatuses, for example, such uneven image appearance is caused by variation in the thickness of liquid crystal display cells, the thickness of electrode patterns, etc.

A circular uneven appearance has a circular shape appearing on the screen, and is caused by a locally different cell thickness (thinner or thicker) than surrounding areas, local abnormality of TFT characteristics, local abnormality of electrode pattern size, the presence of a pinhole in the orientation layer, the inadvertent mixing of tarnishing foreign material, etc. A band uneven appearance has a band shape appearing on the screen, and is caused by variation in the size of electrode patterns, variation in the size of BM patterns, variation in the way the orientation layer is formed. A frame uneven appearance has a frame shape appearing on the periphery of the screen, and is caused by a different cell thickness around the periphery of the display area. A streak uneven appearance has a streak appearing on the screen, and is caused by abnormal characteristics of TFT that may be present on a bus-line-specific basis. A shot uneven appearance has a rectangular shape appearing on the screen, and is caused by area variation, line width variation, positional displacement, etc., that take place during stepper exposure.

In addition to those uneven appearances as described above, there are uneven appearances having undefined shape that is difficult to describe in word. In most cases, however, uneven appearance appears as an area having a defined shape such as a circle, a band, a rectangle, a line, a periphery frame, etc. If the density of uneven appearance exceeds a spec of the manufactured liquid crystal display apparatus, such apparatus is generally treated as a defect product.

As a method of reducing uneven appearance by use of a circuit, information indicative of the shape and density of an uneven appearance are stored in memory as mapping information, and a liquid crystal display apparatus is controlled based on the stored information to correct the uneven appearance (Patent Document 1). Another method includes specifying the coordinates of a center, specifying spread from the center in four directions, and performing approximation to obtain correction values (Patent Document 2)
Patent Document 1: Japanese Patent Application Publication No. 9-318929
Patent Document 2: Japanese Patent Application Publication No. 11-113019
Patent Document 3: Japanese Patent Application Publication No. 02-108096

In Patent Document 1, the size of data becomes enormous as the area of uneven appearance increases. For example, if uneven appearance occurs in 1/10 the entire display area of XGA (1024×768), a large size memory having approximately a 1-Gbit capacity (1024×768×3/10×8×2×256) is necessary in order to store the mapping information for ±8 level correction with respect to each of 256 gray levels.

In Patent Document 2, uneven appearance is removed by computing correction data based on the center coordinates and spread in the four directions. In reality, however, a function for correction needs to be specified with respect to the spread of uneven appearance from the center in each direction, resulting in a large number of required parameters. Further, although this method can remove an uneven appearance having a circular or ellipse shape, uneven appearances of non-circular shape such as a band uneven appearance, a frame uneven appearance, a streak uneven appearance, a shot uneven appearance, etc., cannot be removed.

Moreover, 8-bit data cannot properly represent the periphery of uneven appearance or the like where unevenness is extremely thin. According to study conducted by the applicants of this application, correction by use of 8-bit data ends up generating step-like level changes at the periphery. In the conventional liquid crystal display apparatus, gray levels are represented by 8 bits (i.e., 256 gray levels). and, in some apparatuses for use in notebook computers, 6-bit gray levels are used. The related-art methods described above give no consideration to the fineness of gray level representation at corrected portions.

Further, addition of a correction circuit for removing uneven appearance results in a cost increase of a controller IC. It is thus necessary to reduce the size of the correction circuit as much as possible. The possibility of having uneven appearance is rather small relative to a total manufacturing quantity. For example, only 0.01% to 1% of the total manufacturing quantity are treated as defect units. When defect units accounting for 0.1% are to be recovered by a cost increase of 50 yen, the 50-yen cost increase is applied to all the units including nondefective units. Business is not profitable unless economical loss caused by the disposal of a defective unit exceeds 50,000 yen.

Accordingly, there is a need for a display correction circuit and a display apparatus which can reduce uneven appearance by use of small size correction data and a simple circuit construction.

There is also a need for a display correction circuit and a display apparatus which can properly reduce uneven appearance even at a portion where the density of uneven appearance is low (thin).

### SUMMARY OF THE INVENTION

It is a general object of the present invention to provide a display correction circuit and a display apparatus that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a display correction circuit and a display apparatus particularly pointed out in the specification in such full, clear, concise, and exact terms as to enable a person having ordinary skill in the art to practice the invention.

To achieve these and other advantages in accordance with the purpose of the invention, the invention provides a circuit for display correction, including a memory which stores first data indicative of size and position of a rectangular region on a display screen and second data indicative of gray level changes in a surrounding region around the rectangular region in an isometric manner with respect to a horizontal direction and a vertical direction, and an image processing unit which adjusts gray levels of image data in response to the first data and the second data stored in the memory.

According to one aspect of the invention, a display apparatus includes a memory which stores first data indicative of size and position of a rectangular region on a display screen and second data indicative of gray level changes in a surrounding region around the rectangular region in an isometric manner with respect to a horizontal direction and a vertical direction, an image processing unit which adjusts gray levels of image data in response to the first data and the second data stored in the memory, and a display unit which displays the image data having the gray levels thereof adjusted that is output from the image processing unit.

According to another aspect of the invention, the image processing unit as described above adjusts the gray levels of the image data by representing the gray levels of the image data by use of 9or more bits in at least a portion of a display area.

In the display correction circuit and the display apparatus as described above, uneven appearance is corrected based on the first data indicative of size and position of a rectangular region and second data indicative of gray level changes in a surrounding region around the rectangular region in an isometric manner with respect to the horizontal direction and the vertical direction. Accordingly, the size of the data for correction is small, and a small-size circuit for simple computation suffices.

The rectangular region can approach a single point by reducing the size of the rectangular region. In the extreme case, the rectangular region is turned into a single point. In such a case, correction is such that its effect decreases toward an outer perimeter within a circle around the specified point. This makes it possible to properly correct a circular uneven appearance. Alternatively, a finite rectangular region may be specified, with the width of the surrounding being set to zero, thereby providing for the correction of a rectangular region. This successfully corrects a shot uneven appearance. The width of the rectangular correction region may be set substantially equal to one line, providing for a streak uneven appearance to be properly corrected. An extension from one edge of the screen to an opposite edge of the screen may be specified to correct a band uneven appearance.

Further, the gray levels for correction may be provided in 512 levels (i.e., 9-bit representation) to achieve the representation of fine brightness. This makes it possible to properly reduce uneven appearance even at a portion where density is low.

Other objects and further features of the present invention will be apparent from the following detailed description when read in conjunction with the accompanying drawings.

### BRIEF DESCRIPTION OF THE DRAWINGS

FIG. 1 is a block diagram showing an example of the construction of a liquid crystal display apparatus according to the invention;

FIG. 2 is an illustrative drawing for explaining correction data for correcting uneven gray levels;

FIG. 3 is a diagram showing the changes of a correction value (gray level shift) according to positions;

FIG. 4 is a diagram showing an example of gray level shifts with respect to the respective gray levels of input image data to be displayed;

FIGS. 5A through 5D are diagrams showing an example of a correction algorithm according to the invention;

FIG. 6 is a chart showing an example of actual correction data for use in an SXGA panel;

FIG. 7 is a block diagram showing an example of a further detailed construction of an image processing apparatus shown in FIG. 1;

FIGS. 8A through 8D are diagrams showing another example of a correction algorithm according to the invention;

FIGS. 9A through 9E are diagrams showing yet another example of a correction algorithm according to the invention;

FIG. 10 is a diagram showing another example of changes of the correction value (gray level shift) according to positions;

FIG. 11 is a diagram showing an example of gray level shifts with respect to respective input gray levels in the case of correction value settings shown in FIG. 10;

FIGS. 12A through 12D are diagrams showing an example of a correction algorithm according to the invention in the case of FIG. 10 and FIG. 11;

FIG. 13 is a drawing for explaining an effect of gray levels on ideal correction values; and

FIG. 14 is a drawing showing a construction that reduces the number of bits through frame modulation after correction using a large number of bits.

### DESCRIPTION OF THE PREFERRED EMBODIMENTS

In the following, embodiments of the present invention will be described with reference to the accompanying drawings.

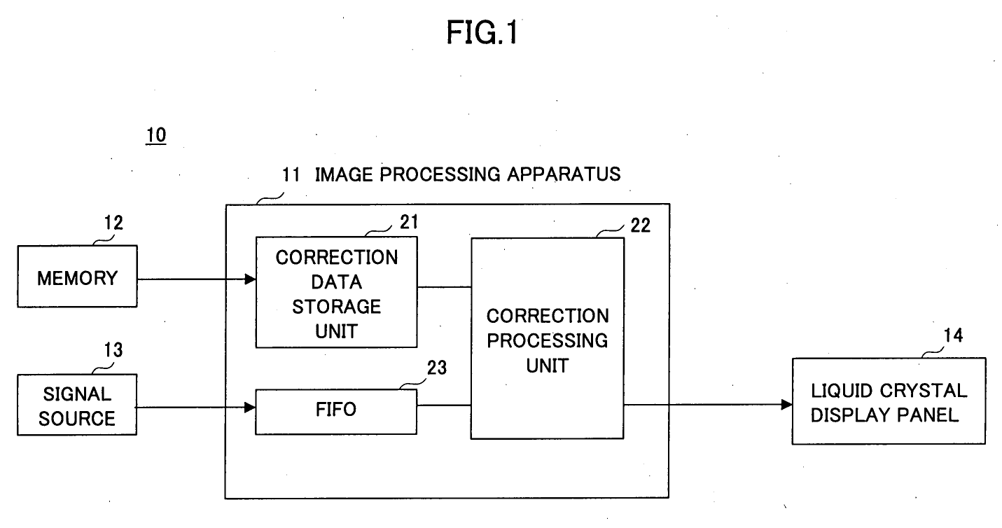

FIG. 1 is a block diagram showing an example of the construction of a liquid crystal display apparatus according to the invention. Although a description will be given here with reference to the liquid crystal display apparatus of FIG. 1, it should be noted that the invention is equally applicable to other types of display apparatuses such as a plasma display apparatus.

A liquid crystal display apparatus 10 of FIG. 1 includes an image processing apparatus 11, a memory 12, a signal source 13, and a liquid crystal display panel 14. The memory 12 stores correction data for use in the correction of uneven appearance. The signal source 13 supplies image data signals for display on the liquid crystal display panel 14. The image processing apparatus 11 corrects the image data signals supplied from the signal source 13 based on the correction data supplied from the memory 12, thereby adjusting the gray levels of the image data signals. The image processing apparatus 11 supplies the image data signals having their gray levels adjusted to the liquid crystal display panel 14. The gray levels of the image data signals are adjusted such as to reduce uneven appearance specific to the liquid crystal display panel 14. This makes it possible to display an image with reduced uneven appearance.

The image processing apparatus 11 includes a correction data storage unit 21, a correction processing unit 22, and a FIFO 23. The correction data storage unit 21 stores the correction data supplied from the correction data storage unit 21, and provide the stored data to the correction processing unit 22. The FIFO 23 receives the image data signals from the signal source 13, and stores a fixed number of data (i.e., display data equal in amount to one frame), followed by supplying the data to the correction processing unit 22 in an order in which the data is received. The correction processing unit 22 corrects the image data signals supplied from the FIFO 23 based on the correction data supplied from the correction data storage unit 21, thereby adjusting the gray levels of the image data signals.

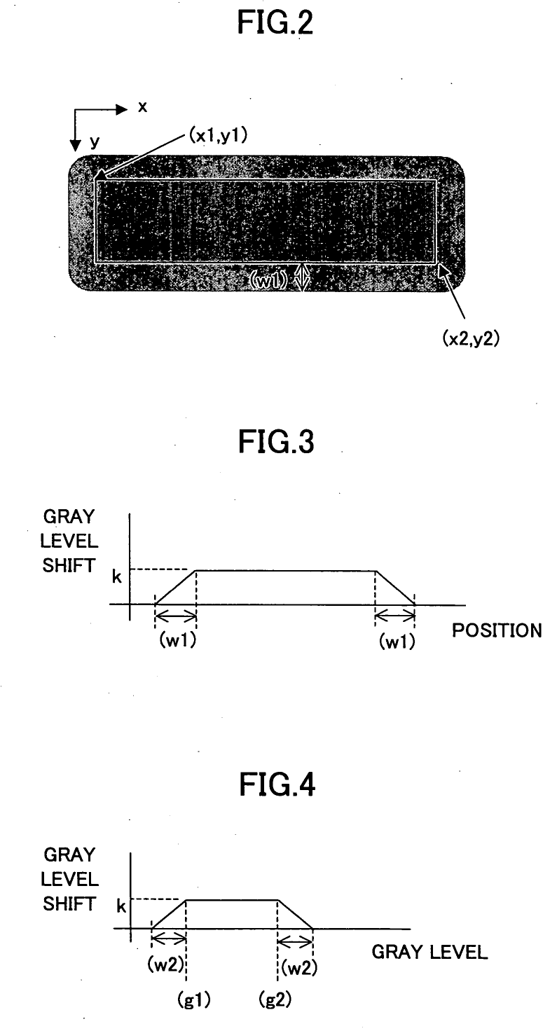

FIG. 2 is an illustrative drawing for explaining the correction data for correcting uneven gray levels.

As shown in FIG. 2, an area to be corrected is specified by two points corresponding to a top left corner (x1, y1) and a bottom right corner (x2, y2) of a rectangular region according to the invention. Within the rectangular region defined by these two points, a constant correction value k is applied, for example. This correction value corresponds to an amount of shift by which a gray level is changed. A surrounding region having a width w1 is defined around the rectangular region, and a correction value is gradually decreased in this surrounding region. That is, the correction value is k at the edge of the rectangular region, and decreases in the surrounding region toward an outer edge of the surrounding region until it becomes zero at distance w1 from the edge of the rectangular region.

FIG. 3 is a diagram showing changes of the correction value (gray level shift) according to positions.

In FIG. 3, a flat portion where the gray level shift is constant at k corresponds to the rectangular region shown in FIG. 2. In an example of FIG. 3, the gray level shift linearly decreases from k to zero in the surrounding region specified as having the width w1. In this embodiment, only the width w1 is specified, thereby defining gray level changes in the surrounding region in an isotropic manner with respect to the x direction and the y direction. The invention thus has an advantage in the small size of correction data.

FIG. 4 is a diagram showing an example of gray level shifts with respect to the respective gray levels of the input image data to be displayed.

Uneven appearance becomes conspicuous when data to be displayed is halftone. Namely, when the display data is close to black (i.e., close to zero) or close to white (i.e., close to 255 in the case of 256 gray levels), there is no need for uneven appearance correction. In the example of. FIG. 4, such characteristics of uneven appearance are taken into consideration, so that the correction value is set to k for halftones inside a range between a gray level g1 and a gray level g2, and decreases as the gray level of interest moves away from this range. Specifically, regions having a width w2 are provided above and below the above range, such that the correction value linearly decreases from k to zero in these regions having the width w2.

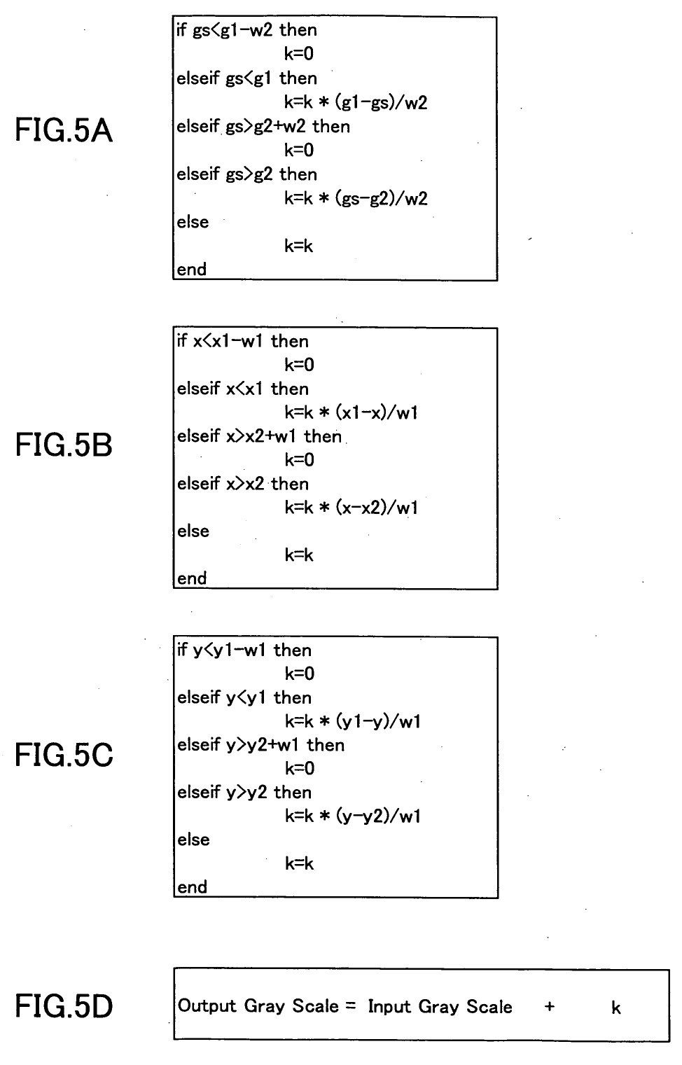

FIGS. 5A through 5D are diagrams showing an example of a correction algorithm according to the invention.

As shown in FIG. 5A, the gray level shift is adjusted according to an input gray level. Specifically, the correction value is set to zero if an input gray level gs is smaller than g1−w2. Otherwise, if gs is smaller than gl, the correction value is set to (k) (g1−gs)/w2. This provides the correction value that linearly increases as the gray level increases. If the input gray level gs is larger than g2+w2, the correction value is set to zero. Otherwise, if gs is larger than g2, the correction value is set to (k)(gs−g2)/w2. This provides the correction value that linearly decreases as the gray level increases. In other areas, the correction value is set to k.

In FIG. 5B, the gray level shift is adjusted according to position. Specifically, the correction value is set to zero if a pixel position x of the input display data is smaller than x1−w1. Otherwise, if x is smaller than x1, the correction value is set to (k)(x1−x)/w1. Here, k is a value of the correction value that is adjusted according to the input gray level as described with reference to FIG. 5A. This provides the correction value that linearly increases in the surrounding region around the rectangular region. If the pixel position x of the input display data is larger than x2+w1, the correction value is set to zero. Otherwise, if x is larger than x2, the correction value is set to (k)(x−x2)/w1. This provides the correction value that linearly decreases in the surrounding region around the rectangular region. In other areas, the correction value is maintained at k. The same adjustment process is also performed in the y direction (FIG. 5C).

At the end, as shown in FIG. 5D, the correction value k obtained in the manner as described above is added to the input gray level (Input Gray Scale) to produce an output gray level (Output Gray Scale).

In the embodiment described above, the rectangular region can approach a single point by reducing the size of the rectangular region, which is situated at the center of a corrected region. In the extreme case, the top left corner (x1, y1) and the bottom right corner (x2, y2) coincide, turning the rectangular region into a single point. In such a case, correction is such that its effect decreases toward the outer perimeter within the radius w1. This makes it possible to properly correct a circular uneven appearance that was described in the background of the invention.

The top left corner (x1 y1) and the bottom right corner (x2, y2) may be provided as separate points to define a rectangular region, and the width w1 of the surrounding region may be set to zero, providing for the correction of a rectangular region. This successfully corrects a shot uneven appearance that was described in the background of the invention. The width of the rectangular correction region may be set substantially equal to one line, providing for a streak uneven appearance to be properly corrected. An extension from one edge of the screen to an opposite edge of the screen may be specified to correct a band uneven appearance.

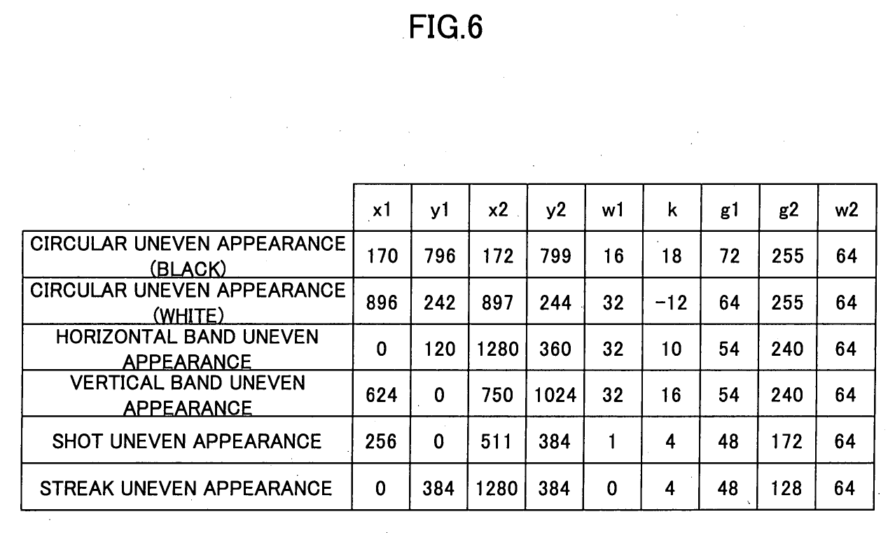

FIG. 6 is a chart showing an example of actual correction data for use in an SXGA panel. The SXGA panel is comprised of 1280-by-768 pixels. Data for panel correction in the case of 8-bit image data are shown in FIG. 6. With respect to uneven appearances having the same circular shape, as shown in FIG. 6, the correction value k is positive for a black uneven appearance (i.e., uneven appearance darker than the surrounding). and is negative for a white uneven appearance (i.e., uneven appearance brighter than the surrounding).

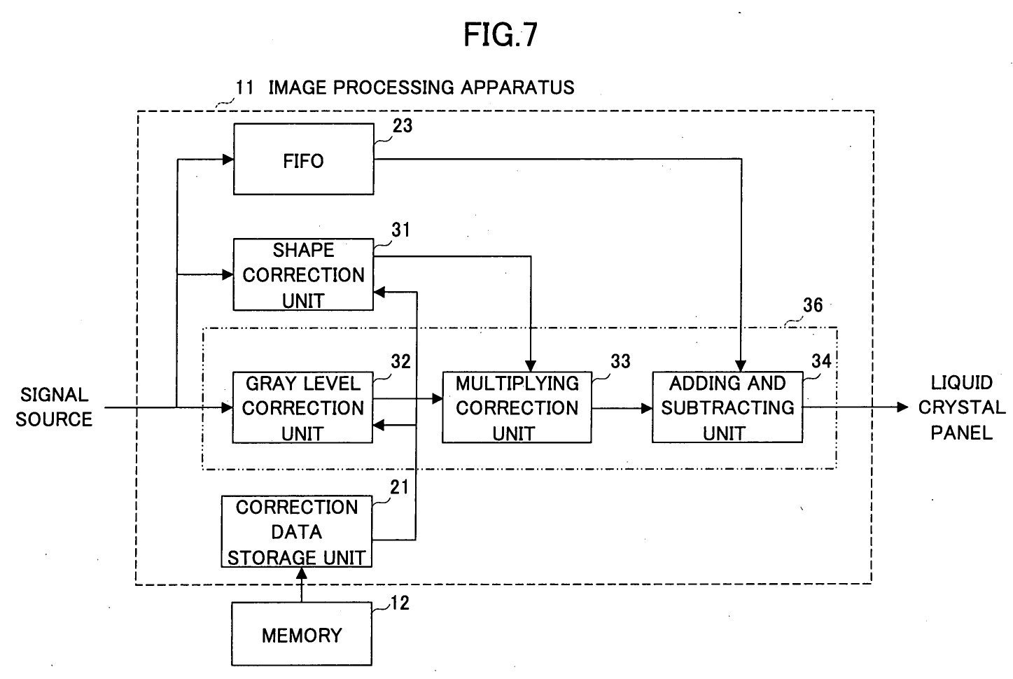

FIG. 7 is a block diagram showing an example of a further detailed construction of the image processing apparatus 11 shown in FIG. 1.

As shown in FIG. 7, the image processing apparatus 11 includes the correction data storage unit 21, the FIFO 23, a shape correction unit 31, a gray level correction unit 32, a multiplying correction unit 33, and an adding and subtracting unit 34.

In FIG. 7, the image processing apparatus 11 may be implemented as an ASIC, for example. The shape correction unit 31 computes correction coefficients according to display coordinates, and, at the same time, the gray level correction unit 32 computes correction coefficients according to input signal gray levels. The correction coefficients obtained by the shape correction unit 31 and the correction coefficients obtained by the gray level correction unit 32 are multiplied by the multiplying correction unit 33, thereby producing correction values (i.e., gray level shifts). In the program shown in FIGS. 5A through 5D, a gray level shift responsive to an input gray level is obtained in FIG. 5A, and a gray level shift responsive to a pixel position (display coordinates) is obtained by multiplication (k=(k responsive to the input gray level)×(coefficient responsive to the display position)) in FIGS. 5B and 5C. In FIG. 7, the correction coefficient responsive to the input gray level and the correction coefficient responsive to the display position are obtained concurrently, and are multiplied to achieve the same computation as in FIGS. 5A through 5D.

The adding and subtracting unit 34 adds the correction value obtained in the manner described above to the image data signals retrieved from the FIFO 23. This performs the correction of uneven appearance with respect to the input display signals. Further, the correction data stored in the memory 12 are temporarily stored in the correction data storage unit 21, and are then supplied to the shape correction unit 31 and the gray level correction unit 32. This makes it possible to cope with any types of uneven appearances such as a circular shape, a band shape, a rectangular shape, a streak shape, a frame shape, etc.

In FIG. 7, the shape correction unit 31 may be provided separately from a processing unit 36 that includes the gray level correction unit 32, the multiplying correction unit 33, and the adding and subtracting unit 34. With such a construction, the processing unit 36 may be provided as many as three, corresponding to respective RGB colors, and the single shape correction unit 31 is shared by all the three RGB colors. With this provision, circuit size can be reduced to a minimum size that is no more than necessary. In general, an uneven appearance. due to a single cause may have different densities for respective RGB colors, but is not likely to have different shapes for different colors. Accordingly, the unit for computing a shape-related correction coefficient is separately provided for shared use by all the colors.

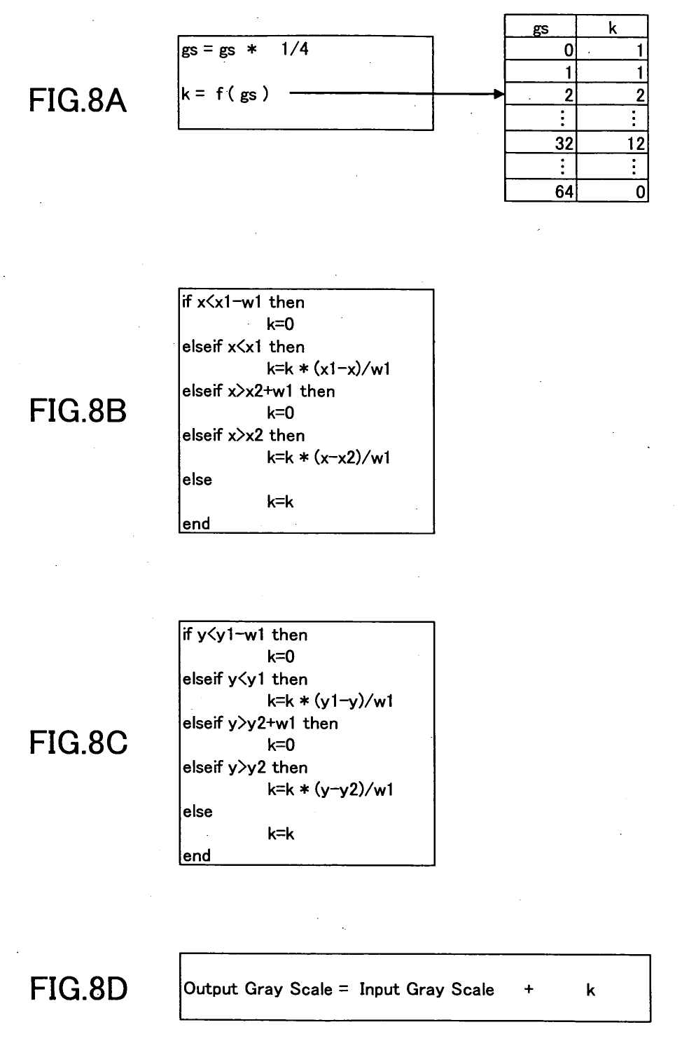

FIGS. 8A through 8D are diagrams showing another example of a correction algorithm according to the invention.

In the algorithm of FIG. 5, simple linear computation is performed by a logic circuit, thereby adjusting a correction value according to the gray level of input data. Depending on the types of uneven appearances, however, density may become higher or lower with respect to specific gray levels, resulting in linear approximation failing to properly represent the density of uneven appearance. Further, circuit-based approximation requires a large number of multiplications. Since multiplication computation results in a drastic increase in the number of data bits, circuit size is greatly affected.

In the embodiment shown in FIGS. 8A through 8D, the computation of a correction value responsive to the input gray level is not performed, but instead the correction value is retrieved from a lookup table 40 (f(gs) in FIG. 8A) stored in memory. Data of the lookup table 40 is a one-dimensional data array corresponding to respective gray levels, so that its data size is sufficiently small so as not to give rise to a problem in terms of circuit size. Further, there is an advantage in that such data can be freely adjusted according to the characteristics of uneven appearance. The algorithm shown in FIGS. 8B through 8D are the same as that of FIG. 5B through 5D.

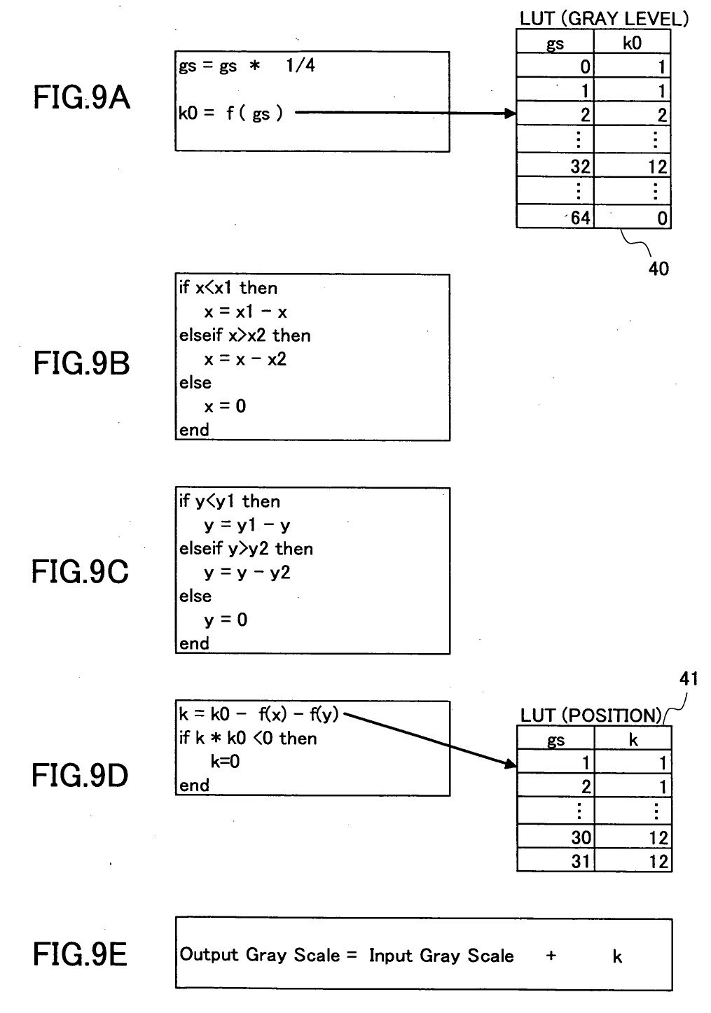

FIGS. 9A through 9E are diagrams showing yet another example of a correction algorithm according to the invention.

As shown in FIG. 9D, a correction value responsive to a display position is obtained by retrieving data from a lookup table 41. In FIG. 9D, f(x) obtains data from the lookup table 41 according to a position in the x direction, and f(y) obtains data from the lookup table 41 according to a position in the y direction. In this manner, this embodiment uses only the lookup table 41 to define gray level shifts in the surrounding of the rectangular region in an isometric manner with respect to the x direction and the y direction. The size of correction data is thus small.

With this provision, the size of a logic circuit can be reduced further. Moreover, since the gray level slope at the periphery of uneven appearance can be controlled by use of desired correction values, rather than by use of linearly approximated correction values, correction is possible even with respect to an uneven appearance that has an irregular distribution of brightness at the periphery. With the algorithm shown in FIGS. 9A through 9E, however, the surrounding region near the corners of the rectangular region has a straight-line outer boundary as opposed to a round (circular) boundary of the previous embodiments. When a circular uneven appearance is to be removed, thus, a corrected region becomes an octagonal shape rather than a circular shape. However, a difference between an octagonal shape and a circular shape does not present a problem in appearance if the density of uneven appearance is low. If a smooth curve instead of a straight line is desired at the corners, correction data relating to the x and y coordinates may be stored in the lookup table exclusively for the corners.

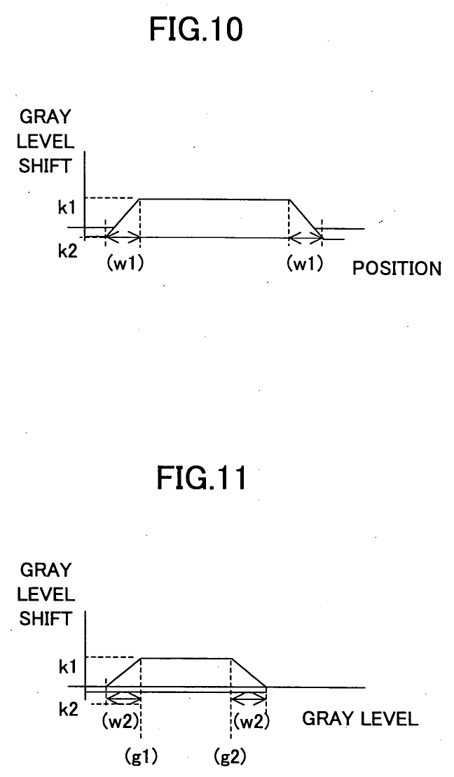

FIG. 10 is a diagram showing another example of changes of the correction value (gray level shift) according to positions. FIG. 11 is a diagram showing an example of gray level shifts with respect to respective input gray levels in the case of correction value settings shown in FIG. 10.

FIG. 10 and FIG. 11 correspond to FIG. 3 and FIG. 4, respectively. In FIG. 3, the gray level shift is zero outside the surrounding region defined by the width w1. In FIG. 10, on the other hand, the correction value is not zero outside the correction region, but is set to a correction value k2 that can be any desired value. Inside the rectangular region, the correction value is shown as k1. In the case of a frame uneven appearance described in the background of the invention, a center portion of a panel may have proper brightness while a periphery portion has abnormal brightness. In such a case, k1 is set to zero, and k2 is set to a correction value for the periphery portion, thereby reducing the frame uneven appearance. When k2 is set to zero, the operation becomes identical to that of the embodiment shown in FIG. 3. Accordingly, the method shown in FIG. 10 and FIG. 11 is capable of handling any exemplary types of uneven appearances.

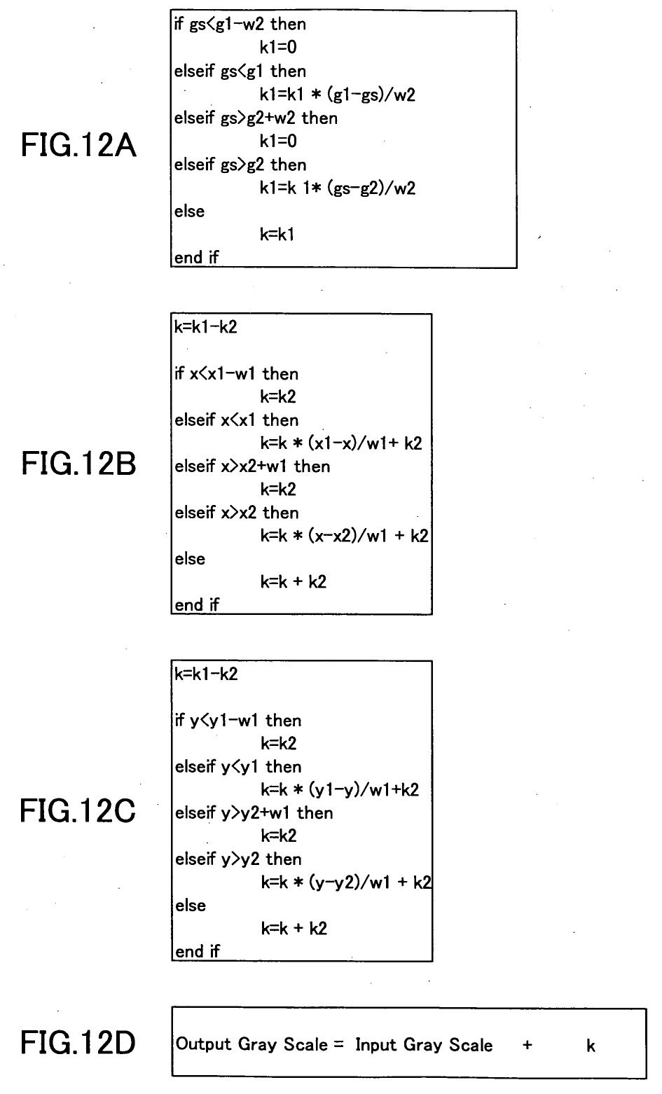

FIGS. 12A through 12D are diagrams showing an example of a correction algorithm according to the invention in the case of FIG. 10 and FIG. 11.

As shown in FIG. 12A, the gray level shift is adjusted according to an input gray level. Specifically, the correction value k1 is set to zero if an input gray level gs is smaller than g1−w2. Otherwise, if gs is smaller than g1, the correction value k1 is set to (k1) (g1−gs)/w2. This provides the correction value that linearly increases as the gray level increases. If the input gray level gs is larger than g2+w2, the correction value k1 is set to zero. Otherwise, if gs is larger than g2, the correction value kl is set to (kl) (gs−g2)/w2. This provides the correction value that linearly decreases as the gray level increases. In other areas, the correction value k1 is maintained at k1.

In FIG. 12B, the gray level shift is adjusted according to position. Specifically, the correction value k is initially set to k1−k2. The correction value k is set to k2 if a pixel position x of the input display data is smaller than x1−w1. Otherwise, if x is smaller than x1, the correction value is set to (k) (x1−x)/w1+k2. This provides the correction value that linearly increases in the surrounding region around the rectangular region. If the pixel position x of the input display data is larger than x2+w1, the correction value k is set to k2. Otherwise, if x is larger than x2, the correction value k is set to (k) (x−x2)/w1+k2. This provides the correction value that linearly decreases in the surrounding region around the rectangular region. In other areas, the correction value k is set to k+k2, i.e., set to k1. The same adjustment process is also performed in the y direction (FIG. 12C).

At the end, as shown in FIG. 12D, the correction value k obtained in the manner as described above is added to the input gray level (Input Gray Scale) to produce an output gray level (Output Gray Scale).

In the embodiments described heretofore, the fineness of gray levels of the corrected portion has been disregarded. The fineness of gray levels is an important factor for the correction of uneven appearance. Typical drive ICs have 8-bit outputs for representing 256 gray levels. In the case of notebook-type equipment, 6-bit outputs may be used to represent 64 gray levels.

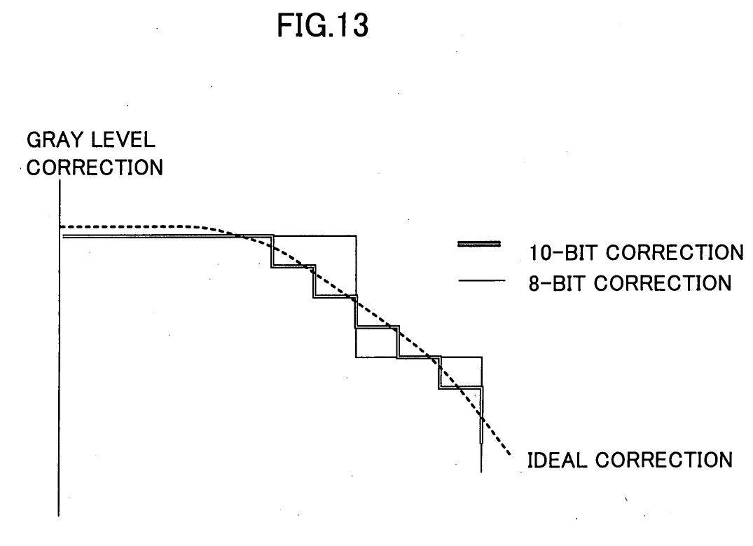

FIG. 13 is a drawing for explaining an effect of gray levels on ideal correction values.

When an uneven appearance has density equivalent to two gray levels out of 256 gray levels, for example, correction based on 8-bit representation results in two large step changes of correction values as shown by single solid lines in FIG. 13. In this case, deviations from the ideal correction values are significant, thereby creating step-like artifacts at the periphery of uneven appearance on the actual display screen. If correction is performed based on 10-bit representation, on the other hand, deviations from the ideal correction values are insignificant as shown by double solid lines in FIG. 13, thereby creating almost no step-like artifacts. Experimental results indicated that at least 9 bits of fine representation were necessary for proper correction of uneven appearance.

For proper correction of uneven appearance, an output driver IC having an output of 9 bits or more may be used. The use of such construction, however, results in a cost increase of driver ICs. Accordingly, there is a need for a scheme that properly corrects uneven appearance while continuing the use of an 8-bit (or 6-bit) driver IC.

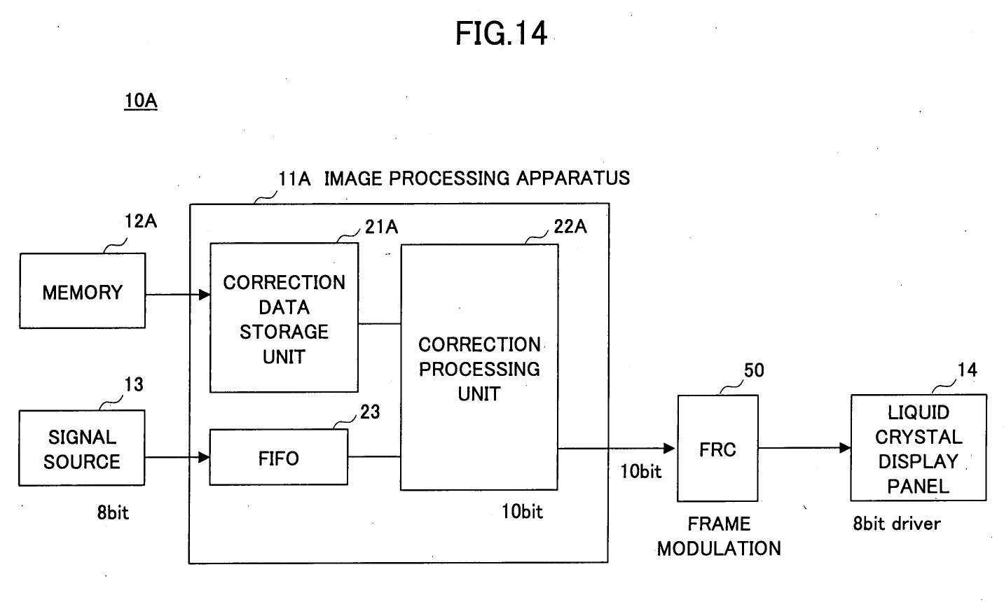

FIG. 14 is a drawing showing a construction that reduces the number of bits through frame modulation after correction using a large number of bits. In FIG. 14, the same elements as those of FIG. 1 are referred to by the same numerals.

A liquid crystal display apparatus 10A of FIG. 14 includes an image processing apparatus 11A, a memory 12A, the signal source 13, a frame modulation unit (FRC) 50, and the liquid crystal display panel 14. The image processing apparatus 11A includes a correction data storage unit 21A, a correction processing unit 22A, and the FIFO 23.

The memory 12A stores correction data for use in the correction of uneven appearance as 10-bit data. The signal source 13 supplies 8-bit image data signals for display on the liquid crystal display panel 14. The correction processing unit 22A of the image processing apparatus 11 converts into 10-bit data the 8-bit image data signals supplied from the signal source 13 through the FIFO 23, and corrects the 10-bit data based on the correction data supplied from the memory 12A through the correction data storage unit 21A, thereby adjusting the gray levels of the 10-bit image data signals. The image processing apparatus 11A supplies the 10-bit image data signals having their gray levels adjusted to the frame modulation unit 50. The frame modulation unit 50 converts the 10-bit image data into 8-bit image data, and represents the 1024 gray levels of the 10-bit image data by the 8-bit image data by use of frame modulation. The 8-bit frame-modulated image data is supplied to the liquid crystal display panel 14. This makes it possible to display an image with reduced uneven appearance.

10-bit computation for gray level adjustment (correction) described above may be performed only with respect to a portion of an image display area where correction is necessary, and the remaining portion may be maintained as 8-bit data.

Although the above embodiments have been described with reference to a liquid crystal display apparatus, uneven appearance occurs in various types of display apparatuses. The present invention is applicable to any type of display apparatus in which uneven appearance is observed as a problem.

Further, the present invention is not limited to these embodiments, but various variations and modifications may be made without departing from the scope of the present invention.

The present application is based on Japanese priority application No. 2003-369317 filed on Oct. 29, 2003, with the Japanese Patent Office, the entire contents of which are hereby incorporated by reference.

1. A circuit for display correction, comprising:
a memory which stores first data indicative of size and position of a rectangular region on a display screen and second data indicative of gray level changes in a surrounding region around the rectangular region in an isometric manner with respect to a horizontal direction and a vertical direction; and
an image processing unit which adjusts gray levels of image data in response to the first data and the second data stored in said memory.

2. The circuit as claimed in claim 1, wherein the first data includes:
data indicative of one corner of the rectangular region; and
data indicative of another corner opposite said one corner of the rectangular region.

3. The circuit as claimed in claim 1, wherein the first data specifies said one corner and said another corner as an identical point.

4. The circuit as claimed in claim 1, wherein said second data is data indicative of a width of the surrounding region, and said image processing unit linearly changes the gray levels of the image data in the horizontal direction and in the vertical direction in the surrounding region having said width.

5. The circuit as claimed in claim 1, wherein said second data is data indicative of a width of the surrounding region and a lookup table, and said image processing unit changes the gray levels of the image data in the horizontal direction and in the vertical direction according to the lookup table in the surrounding region having said width.

6. The circuit as claimed in claim 1, wherein said memory further stores third data for adjusting the gray levels of the image data according to brightness of the image data, and said image processing unit adjusts the gray levels of the image data in response to the third data.

7. The circuit as claimed in claim 6, wherein said image processing unit includes:
a first circuit which performs computation based on the first data and the second data for adjusting the gray levels of the image data; and
a plurality of second circuits, each of which performs computation based on the third data for adjusting the gray levels of the image data,
wherein said second circuits are provided separately for respective colors, and said first circuit is provided for shared use by all the colors.

8. The circuit as claimed in claim 1, wherein said image processing unit adjusts the gray levels of the image data by representing the gray levels of the image data by use of 9 or more bits in at least a portion of a display area.

9. The circuit as claimed in claim 1, further comprising a frame modulation unit which converts the image data from 9 or more bits into 8 or less bits, and frame-modulates the converted image data.

10. A display apparatus, comprising:
a memory which stores first data indicative of size and position of a rectangular region on a display screen and second data indicative of gray level changes in a surrounding region around the rectangular region in an isometric manner with respect to a horizontal direction and a vertical direction;
an image processing unit which adjusts gray levels of image data in response to the first data and the second data stored in said memory; and
a display unit which displays the image data having the gray levels thereof adjusted that is output from said image processing unit.
